(19) United States
(12) Patent Application Publication
(10) Pub. No.: US 2007/0210644 A1
(43) Pub. Date: Sep. 13, 2007

(54) Actuation device for a brake

(75) Inventors: Peter Streipardt, Waltershausen (DE); Matthias Habel, Gotha (DE); Dirk Bald, Gotha (DE); Christian Stammberger, Gotha (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/714,362

(22) Filed: Mar. 6, 2007

(30) Foreign Application Priority Data
Mar. 8, 2006 (DE) 102006010677.6

(51) Int. Cl. B60T 17/16

(52) U.S. Cl. 303/89

(57) ABSTRACT

An actuation device for a brake has an accumulator (14). The accumulator (14), when in a parking brake position, acts on a ball ramp actuator (10) via a connecting element to actuate the brake as a parking brake. If the accumulator (14) is in a released position, an actuator (16) is activated to displace a catch (17) and to hold the accumulator (14) in this released position.

This application claims priority from German Application Serial No. 10 2006 010 677.6 filed Mar. 8, 2006.

### FIELD OF THE INVENTION

The invention concerns an actuation device for a brake.

### BACKGROUND OF THE INVENTION

DE 102 25 038 A1 discloses a drive axle with an integrated brake that features an actuation device in the form of a ball ramp, which acts on the multi-disc brake, where the axle can feature a positive service brake with a positive or negative parking brake or a negative service brake with a positive or negative parking brake. For an actuation unit, a mechanically, hydraulically and/or electrically activated actuation unit can be employed.

The object of the present invention is to further improve the way in which the service and parking brakes work together and to increase the effectiveness of the parking brake.

### SUMMARY OF THE INVENTION

According to the invention, the actuation device features a means for operating the brake as a service brake and a means for operating the brake as a parking brake, where the parking brake features an actuator and an accumulator, where the accumulator, while in its parking brake position, indirectly exerts a force on the brake, whereby the vehicle is held in position in the manner of a parking brake. To release the parking brake, the actuator is activated, which causes the accumulator to open and presses it back into a released position. This actuator can be activated electrically, mechanically or through muscle strength. The actuation unit also features a retaining means, by way of which the accumulator can be held in its released position even when the actuator for moving the accumulator is no longer being activated. It is thus possible to switch off the actuator for moving the accumulator, thereby relieving the driver when muscle strength is used for actuation. Switching off the actuator can improve the degree of effectiveness in an electrical or mechanically actuated system as well.

The retaining means is operated via an actuator, which can be activated itself if the accumulator is in a released position. The retaining means is preferably a catch that can engage the accumulator in a way that holds it in a position. For example, the catch can be actuated by an electromagnet.

In a further embodiment, the retaining means, for example a catch, is actuated and the spring assembly is thereby held in its position until the driver manually switches off the actuator for actuating the retaining means or the actuator is automatically switched off by, for example, having the actuator connected to a seat switch in the vehicle, whereby the driver's leaving the vehicle causes the seat switch to automatically disrupt the actuator for the retaining means, causing the retaining means to release the accumulator and operate the brake as a parking brake. This also allows the possibility of automatically engaging the parking brake in the event of a complete loss of power in the vehicle.

### BRIEF DESCRIPTION OF THE DRAWINGS

The invention will now be described, by way of example, with reference to the accompanying drawings in which:

FIG. 1 is a forklift;

FIG. 2 is an electrically driven axle, and

FIG. 3 is a schematic illustration of an actuation device for the electrically driven axle.

### DETAILED DESCRIPTION OF THE INVENTION

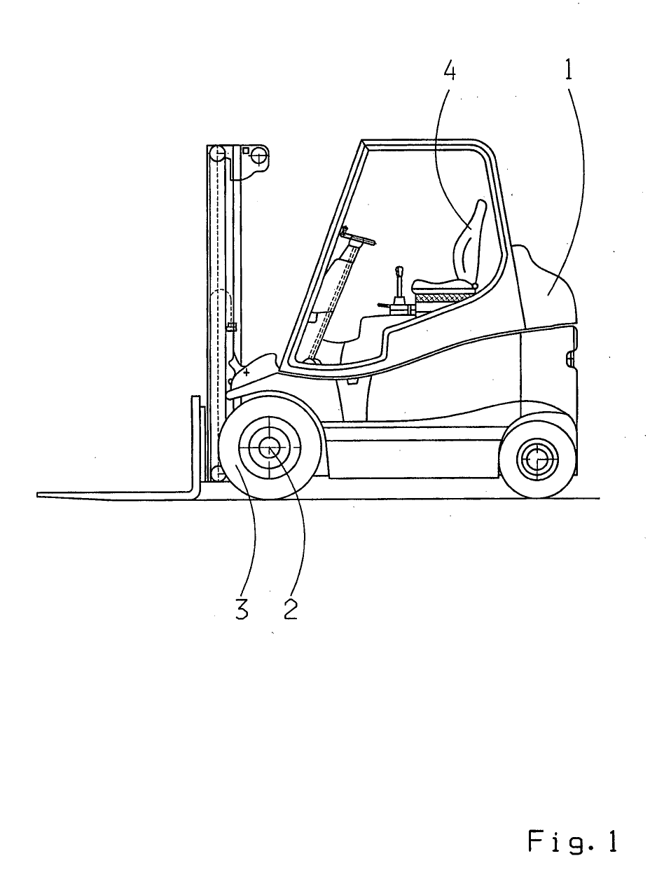

FIG. 1:

A forklift 1 drives driving wheels 3 via an electrically driven axle 2. The forklift 1 features a seat switch in a seat 4, which is interrupted when the driver leaves the vehicle.

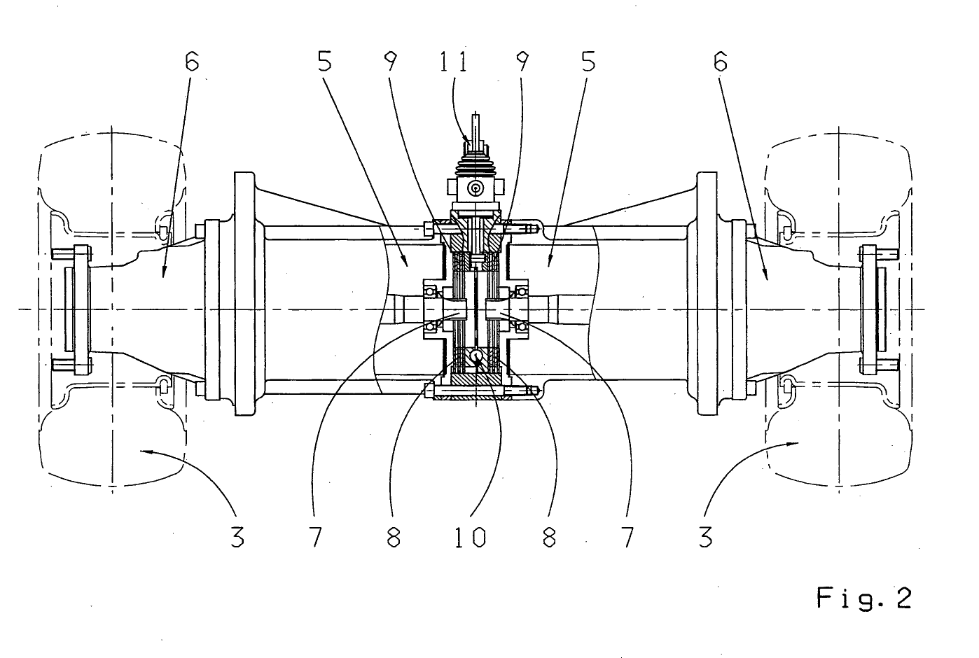

FIG. 2:

On each side of the axle 2, an electrical drive motor 5 drives the driving wheel 3 via a reduction gearbox 6. Each shaft 7 of the drive motor 5 is connected to discs 8 of a multi-disc brake 9. A ball ramp actuator 10 is activated by a connecting element 11 to engage the multi-disc brake 9. The ball ramp actuator 10 is located between discs 8 of the multi-disc brake 9, which thus consists of two individual brakes with a common actuator.

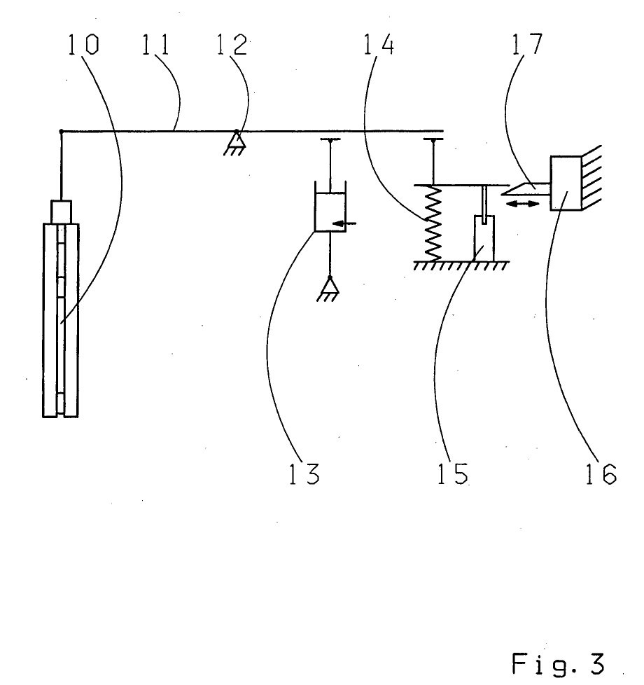

FIG. 3:

The ball ramp actuator 10 is activated by the connecting element 11. The connecting element 11 is fixedly mounted on a bearing 12. An actuator 13, in the form of a hydraulic cylinder, is connected to the connecting element 11 in such a way that the pressure admission of the actuator 13 exerts a force on the connecting element 11. For example, the actuator 13 is connected to a brake pedal in the vehicle, whereby the actuator 13 operates the brake as a service brake. The bearing 12 is arranged between the ball ramp 10 and the actuator 13. In a parking position, an accumulator 14 presses on the connecting element 11 and thus operates the ball ramp actuator 10 as a parking brake. The bearing 12 is arranged between the ball ramp actuator 10 and the accumulator 14. When activated, an actuator 15 which, for example, can be designed as an electrically, mechanically or muscle-activated actuator, moves the accumulator 14 out of its parking brake position and into a released position in which the ball ramp actuator 10 is disengaged. If the accumulator 14 is in the released position, an actuator 16 can move a catch 17 in such a way that the accumulator remains held in the released position. If the actuator 16 is no longer activated, the catch 17 automatically retracts and this retaining means releases the accumulator 14, causing it to activate the ball ramp actuator 10 into engagement when the actuator 15 is not activated. The actuator 16 can also be connected to the seat switch of the seat 4 in FIG. 1, thereby resulting in automatic engagement of the parking brake when the driver leaves the vehicle.

### REFERENCE NUMERALS

1 forklift vehicle

2 axle

3 driving wheels

4 seat

5 drive motor

6 reduction gearbox

7 shaft

8 discs

9 multi-disc brake

10 ball ramp actuator

11 connecting element

12 bearing

13 actuator

14 accumulator

15 actuator

16 actuator

17 catch

1-6. (canceled)

7. An actuation device for a brake (9) of a forklift vehicle (1) having a means (13) for operating the brake as a service brake and a means (14) for operating the brake as a parking brake, wherein the means (14) for operating the brake as the parking brake has an accumulator (14) which, in a parking brake position, exerts a force on the brake (9) such that the brake (9) is engaged, the accumulator (14) is activated by a first actuator (15) into a released position to disengage the brake (9), in the released position, the accumulator (14) exerts no force on the brake (9), a retaining means (17) is operated by a second actuator (16) such that when the accumulator (14) is in the released position, the accumulator (14) is held in the released position, if the first actuator (15) for operating the accumulator (14) is not activating the accumulator (14).

8. The actuation device according to claim 7, wherein the actuation device further comprises a ball ramp (10) which operates a multi-disc brake (9), and the ball ramp (10) is activated via a fixedly mounted connecting element (11).

9. The actuation device according to claim 8, wherein the means (13) for operating the brake (9) as a service brake and the means (14) for operating the brake (9) as a parking brake both communicate with the connecting element (11).

10. The actuation device according to claim 9, wherein a fixedly positioned bearing (12) is located between the ball ramp (10) and both the means (13) for operating the brake (9) as a service brake and the means (14) for operating the brake (9) as a parking brake.

11. The actuation device according to claim 9, wherein the means (13) for operating the brake (9) as a service brake and the means (14) for operating the brake (9) as a parking brake only act on the connecting element in a sense of engagement.

12. An electrically driven axle with a ball ramp (10) which communicates with a brake (9) for engaging the brake (9), the electrically driven axle having a means (13) for operating the brake (9) as a service brake and a means (14) for operating the brake (9) as a parking brake, the means (14) for operating the brake (9) as the parking brake comprises an accumulator (14) which, in a parking brake position, exerts a force on the brake (9) whereby the brake (9) engaged, and the accumulator (14) is operated by a first actuator (15) to disengage and thereby be brought into a released position, in which the accumulator (14) exerts no force on the brake (9), a retaining means (17) is additionally operated by means of a second actuator (16), when the accumulator (14) is in the released position, the accumulator (14) is also held in the released position, when the first actuator (15) for operating the accumulator (14) operates the accumulator (14) not in a sense of opening.

13. An device for actuating a brake (9) of a forklift vehicle (1), the device comprising:
a first actuator (13) communicating with the brake (9) for actuating the brake (9) as a service brake;
an accumulator (14) communicating with the brake (9) for operating the brake (9) as a parking brake;
the accumulator (14), when in a parking brake position, exerts a force on the brake (9) such that the brake (9) is engaged,
a second actuator (15) biasing the accumulator (14) into a released position for disengaging the brake (9), and the accumulator (14), when in the released position, exerts no force on the brake (9); and
when the accumulator (14) is in the released position and the second actuator (15) is not biasing the accumulator (14) into a released position to disengage the brake (9), a third actuator (16) activates a retaining means (17) for retaining the accumulator (14) in the released position.
